(19) United States
(12) Patent Application Publication
(10) Pub. No.: US 2026/0365159 A1
(43) Pub. Date: Nov. 19, 2026

(54) SYSTEM AND METHOD FOR OPTIMIZING PARKING AND BATTERY HEALTH FOR INDIVIDUAL VEHICLES

(71) Applicant: NISSAN NORTH AMERICA, INC., Franklin, TN (US)

(72) Inventors: Tengfei GONG, Milpitas, CA (US); Aaron KANDEL, San Francisco, CA (US); Yoshinori SUZUE, Mountainview, CA (US)

(21) Appl. No.: 19/211,124

(22) Filed: May 16, 2025

(51) Int. Cl. B60W 30/06; B60L 53/36; B60W 50/00

(52) U.S. Cl. CPC B60W 30/06; B60W 50/00; B60L 53/36; B60W 2050/0026; B60W 2050/0028; B60W 2510/248; B60W 2540/215; B60W 2555/20; B60W 2556/45; B60W 2756/10

(57) ABSTRACT

A system for managing a battery of a vehicle is provided. The system includes a server and a controller. The server is configured to, for each parking session at a plurality of locations, acquire parking information for the vehicle including: information regarding the battery of the vehicle, a weather condition in a predetermined area near the location, and geospatial information regarding an area surrounding the location. The controller is configured to determine, using a lookup table or a machine learning model, at least one parking score for each of the plurality of locations based on the parking information for the location. The controller is configured to determine a recommended parking location for the vehicle from the plurality of locations based on the parking scores.

### BACKGROUND

### Field of the Invention

The present disclosure generally relates to a system for managing the battery of a vehicle by optimizing parking, and a process for managing the battery of the vehicle using the system.

### Background Information

Electric vehicles (“EVs”) are desirable because they are more environmentally friendly than traditional gasoline-powered vehicles, and they offer users the benefits of lower fuel costs and less maintenance. EVs can also be used with vehicle grid integration systems (“VGIs”) to decrease the peak power demand and save on power costs. In particular, the VGI can draw power from a demand source connected to the grid to charge the EVs and can discharge the EVs to provide power to the demand source to reduce the peak power demand of the demand source and thereby save energy cost

However, there are some drawbacks with conventional EVs. For example, EVs often have a limited driving range as compared with gasoline-powered vehicles. Furthermore, the battery health of an EV battery degrades over time and such degradation further decreases the driving range of the EV and the life of the EV battery. Therefore, there is a need for a solution to manage the EV battery to improve battery health and thereby extend the life of the EV battery.

It has been known to perform smart charging to avoid charging risk events. In particular, it has been known to adjust a charging strategy for an EV based on environmental data indicating a potential loss or an increased risk of an internal short circuit. However, conventional smart charging processes fail to consider parking conditions or external temperature when determining the charging strategy.

It has also been known to consider temperature generally in determining an aging factor to improve the accuracy in estimating a state of health of an EV battery. However, these state of health models fail to consider parking conditions or temperature impacts during a parking session for the EV.

It has been further known to perform smart preconditioning of an EV battery to maintain an optimal battery temperature when the EV is not in operation. In these processes, external power sources or stored energy can be used to heat or cool the EV battery to prevent degradation. However, these preconditioning processes also fail to consider parking conditions or external temperatures during a parking session when determining how to precondition the EV battery. Therefore, further improvement is needed to develop a system of better managing the battery of an EV by preventing degradation of the battery health.

### SUMMARY

It has been discovered that the temperature and environmental conditions during parking of an EV can have a significant impact on long-term health of the EV battery. For example, a shaded parking location during a predetermined time of day can be much better for battery health than the same parking location exposed to heavy sunlight during another time of day. Furthermore, the type of parking (garage versus street parking) and external temperature can also affect the battery health. Therefore, it has been discovered that the battery health of EVs can be improved by providing a system and method in which parking scores and a parking recommendation are provided for users of the EVs. In particular, by providing parking scores and a parking recommendation for an EV, the long-term health of the EV battery can be improved by taking into consideration parking conditions such as external temperature and environmental conditions (i.e., type of parking and whether the area is shaded) and recommending optimal parking locations for the EV.

In view of the state of the known technology, one aspect of the present disclosure is to provide a system for managing a battery of a vehicle. The system includes a server and a controller. The server is configured to, for each parking session at each of a plurality of locations, acquire parking information for the vehicle during the parking session. The parking information includes: information regarding the battery of the vehicle, a weather condition in a predetermined area around the location, and geospatial information regarding an area surrounding the location. The controller is configured to determine at least one parking score for each of the plurality of locations based on the parking information for the location, the controller being configured to determine the parking scores using a lookup table or a machine learning model. The controller is configured to determine a recommended parking location from the plurality of locations based on the parking scores.

Another aspect of the present disclosure is to provide a system for managing a plurality of batteries of a plurality of vehicles. The system includes a server and a controller. The server is configured to, for each parking session for each of the plurality of vehicles at each of a plurality of locations, acquire parking information for one of the plurality of vehicles during the parking session. The parking information includes: information regarding the battery of the one of the plurality of vehicles, a weather condition in a predetermined area around the location, and geospatial information regarding an area surrounding the location. The controller is configured to determine at least one parking score for each of the plurality of locations based on the parking information for the location, the controller being configured to determine the parking scores using a lookup table or a machine learning model. The controller is configured to determine a recommended parking location for one of the plurality of vehicles from the plurality of locations based on the parking scores.

A further aspect of the present disclosure is to provide a method of managing a battery of a vehicle. The method includes acquiring, for each parking session at each of a plurality of locations, parking information for the vehicle during the parking session. The parking information includes: information regarding the battery of the vehicle, a weather condition in a predetermined area around the location, and geospatial information regarding an area surrounding the location. The method further includes determining at least one parking score for each of the plurality of locations based on the parking information for the location, the parking scores being determined using a lookup table or a machine learning model. The method includes determining a recommended parking location for the vehicle from the plurality of locations. The recommended parking location is determined based on the parking scores.

By providing a system and method in which a parking recommendation for a vehicle is made based on information regarding the battery, a weather condition near the parking location, and geospatial information regarding an area around the parking location, the system and method can improve the long-term battery health of the vehicle. In particular, by providing parking scores and a parking recommendation for the vehicle, the health of the vehicle battery can be improved by taking into consideration parking conditions such as external temperature and environmental conditions (i.e., type of parking and whether the area is shaded) and recommending optimal parking locations for the vehicle.

### BRIEF DESCRIPTION OF THE DRAWINGS

Referring now to the attached drawings which form a part of this original disclosure:

FIG. 1 is a schematic view of a system for providing a parking recommendation for a vehicle based on parking scores according to a first embodiment;

FIG. 2 is a schematic view of a system for managing a battery of a vehicle according to a second embodiment;

FIG. 3 is a schematic view of a system for providing parking recommendations for a plurality of vehicles based on parking scores according to a third embodiment;

FIG. 4 is an illustrated flow chart showing a process of managing the battery of a vehicle according to a fourth embodiment;

FIG. 5 is a chart showing parking scores for various parking locations in an area on a map according to a fifth embodiment;

FIG. 6 is an illustrated flow chart showing a process of managing the battery of a vehicle according to a sixth embodiment;

FIG. 7 is an illustrated flow chart showing a process of managing the battery of a vehicle according to a seventh embodiment;

FIG. 8 is an illustrated flow chart showing a process of managing the battery of a vehicle according to an eighth embodiment; and

FIG. 9 is an illustrated chart showing a system of managing the batteries of a plurality of vehicles according to a ninth embodiment.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

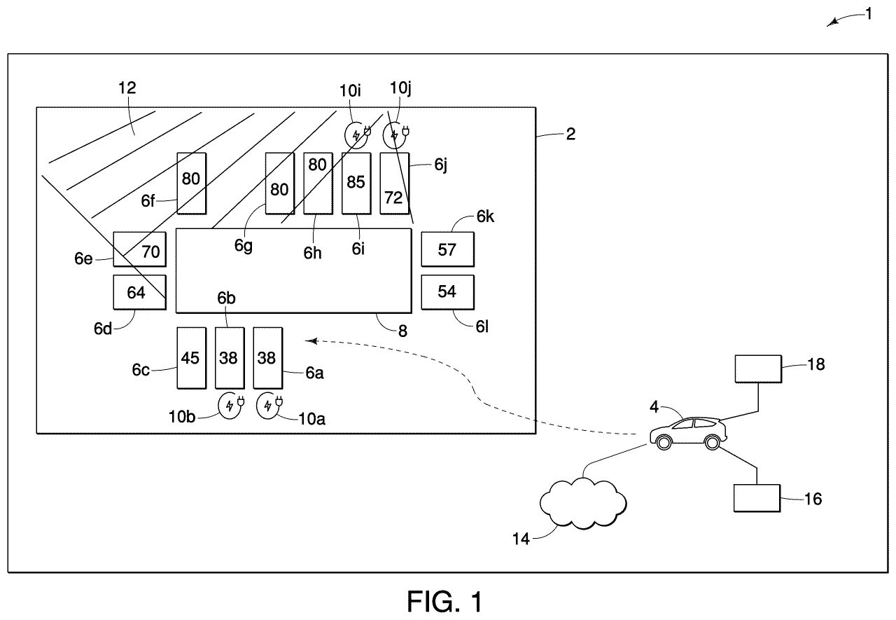

Referring initially to FIG. 1, a system 1 for providing a parking recommendation for a vehicle is illustrated according to a first embodiment. The system 1 includes a parking lot 2, a vehicle 4, a plurality of parking spots 6a-6l, a building 8, a plurality of charging stations 10a-10b and 10i-10j, a shaded area 12, a cloud server 14, a controller 16 and a user terminal 18.

As shown in FIG. 1, the parking lot 2 includes the parking spots 6a-6l and is adjacent to the building 8. The parking lot 2 can also include a plurality of charging stations 10a-10b and 10i-10j for charging electric vehicles parked in the parking lot 2.

The vehicle 4 is any suitable electric vehicle that includes a battery and can be charged and discharged, such as a hybrid vehicle or a fully electric vehicle. The vehicle 4 can include a bidirectional charging port that is configured to allow charging and discharging of the electric vehicle 4.

As shown in FIG. 1, the parking lot 2 includes a plurality of parking spots 6a-6l around the building 8. Each of the parking spots 6a-6l includes a parking score represented by a number. A higher parking score represents a better or more desirable parking location for optimizing long-term battery health. For example, parking spots 6a, 6b and 6c are provided on the bottom side of the building 8 with no shade provided by the shaded area 12 and therefore have low respective parking scores of 38, 38 and 45. Parking spots 6d and 6e are provided on a left side of the building 8 and are partially shaded by the shaded area 12. Therefore, parking spots 6d and 6e have slightly higher parking scores than parking spots 6a-6c-64 and 70, respectively. Furthermore, parking spot 6e is more shaded than parking spot 6d and, thus, has a slightly higher parking score.

As shown in FIG. 1, parking spots 6f-6j are provided on the top side of the building and are the most shaded parking spots in the parking lot 2. As such, parking spots 6f, 6g, 6h, 6i and 6j have the highest parking scores of all the parking spots 6a-6k-80, 80, 80, 85 and 72, respectively. Parking spots 6k and 6l are provided on the right side of the building 8 with no shade and have relatively low respective parking scores of 57 and 154. Parking spots 6a, 6b, 6i and 6j are all located adjacent to charging stations (i.e., charging stations 10a, 10b, 10i and 10j, respectively). It should be understood that the parking scores for parking spots 6a-6l can vary depending on the time of day.

The building 8 can be any suitable building connected to a power grid. For example, the building 8 can be an office building, a commercial building (e.g., a supermarket or retail store), a public building (e.g., a library) or a residential building (e.g., a house or apartment building). The building 8 is configured to draw power from the power grid to meet its energy demands. For example, the building 8 can be configured to draw power from the power grid to run the systems in the building 8. The building 8 is also configured to draw power from the power grid to supply power to the charging stations 10a-10b and 10i-10j.

The charging stations 10a, 10b, 10i and 10j each include bidirectional charging ports that are configured to supply power to and draw power from a vehicle connected thereto. In FIG. 1, four charging stations 10a, 10b, 10i and 10j are shown. However, it should be understood that any suitable number of charging stations can be provided in the system 1. Alternatively, the charging stations 10a, 10b, 10i and 10j can be unidirectional charging ports that are only configured to supply power to a vehicle connected thereto.

The shaded area 12 is an area near the building 8 that provides shade so that some of the areas of the parking lot 2 are not entirely exposed to the sun. The shaded area 12 can be an area that is covered by a tree or a fabric. It should be understood that the size, shape and location of the shaded area 12 can vary depending on the time of day.

The cloud server 14 is any server configured to transfer and store information regarding the parking spots 6a-6l. For example, the cloud server 14 includes: a wired or wireless communication unit configured to transmit and receive parking information, and a memory configured to store the parking information. The parking information includes information regarding the parking scores for the parking spots 6a-6l, as well as parking scores for other parking locations. The parking information also includes historical data regarding the vehicle, such as information from a telematics control unit of the vehicle regarding the location, usage, and/or battery condition of the vehicle, parking conditions for the vehicle, and any other vehicle condition. The parking information also includes information from online weather and geospatial data services, and information from a machine learning model regarding the parking spots 6a-6l.

The controller 16 is any suitable electronic controller configured to communicate with the vehicle 4 and/or the cloud server 14 to determine the parking scores for the parking spots 6a-6l and to further determine a recommended parking location for the vehicle 4 based on the parking information stored in the cloud server 14. For example, the controller 16 includes one or more processors that execute predetermined control programs to: determine or infer the type of parking environment (e.g., garage, driveway, street, etc.) for the parking spots 6a-6l, and determine or compute the parking score for each of the parking spots 6a-6l based on the inferred parking environment and real-time sensor and environmental data, such as the battery temperature of the vehicle 4, the external temperature of each of the parking spots 6a-6l, and other parking conditions such as the degree of sun exposure, using rule-based logics or machine learning model(s).

The controller 16 can also include the machine learning model(s) used to determine the parking scores for the parking spots 6a-6l. However, it should be understood that the machine learning model(s) can alternatively be located externally to the controller 16 but in communication with the controller 16. The controller 16 can also include a local memory or a local cache that can store a lookup table containing the parking scores for the parking spots 6a-6l. However, it should be understood that the lookup table containing the parking scores can alternatively be stored in a local data cache or memory for the vehicle 4 or a cloud data processor, such as the cloud data server 14.

The controller 16 is configured to determine a recommended parking location from among the parking spots 6a-6l based on the parking scores, for example by choosing the parking spot with the highest parking score or the closest position to the current location. The controller 16 can be configured to generate base scores based on predefined rules regarding the environmental features of the parking spots 6a-6l. For example, if the type of parking environment is determined to be a garage, an average score, such as 50 or 75, can be adjusted by +10 points, and if the environment is determined to be an open shaded area, the score can be adjusted by +5 points, whereas street parking adjusts the score by −5 points, and extreme temperatures in the parking spots 6a-6l adjust the score by −15 points.

Then the controller 16 is configured to assign weights to each of the feature categories and combine the rule-based scores with the weighted adjustments to arrive at a final parking score. For example, the adjustment for parking type (e.g., garage, open shaded area, street parking) can be assigned a weight of 40%, the adjustment for temperature can be assigned a weight of 30%, and other factors can be assigned a weight of 30%. The controller 16 is configured to generate a score for each of the parking spots 6a-6l for each parking session by a user, and aggregate the parking scores over a period of time.

In FIG. 1, the recommended parking location is parking spot 6a. Although this parking location has the lowest parking score, it is the closest to the current location of vehicle 4, and spot 6a is located adjacent to charging station 10a. As such, if the vehicle 4 has a low state of charge and needs to be charged while parking, the proximity to the charging station 10a will be weighed more heavily in determining the recommended parking location for the vehicle 4. However, it should be understood that the recommended parking location can be any suitable location depending on the condition of the vehicle 4, the proximity to a charging station, or the parking score.

The processors of the electronic controller 16 include, for example, a central processing unit (“CPU”) or a micro-processing unit (“MPU”). The processors of the electronic controller 16 can be located at separate positions, with some of the processors being provided in the vehicle 4, and the other processors being provided in a remote server connected to the internet. These processors are connected to one another via a wireless communication device to allow for communication. The electronic controller 16 can include one or more microcomputers. Thus, the term “electronic controller” as used herein refers to hardware that executes a software program, and does not include a human.

The electronic controller 16 is in wired or wireless communication with the vehicle 4, the cloud server 14 and the user terminal 18. For example, the electronic controller 16 can be located inside the vehicle 4 or can be located remotely from the vehicle 4 but in communication with the vehicle 4 and/or user terminal 18, for example via the cloud server 14. The electronic controller 16 can include a communication unit in wired communication with the vehicle 4 and/or the user terminal 18. The electronic controller 16 is configured to send the parking scores and the parking recommendation to the user terminal 18. For example, the user terminal 18 can display the parking scores for each of the parking spots 6a-6l such that the user or driver can select the parking location for the vehicle 4.

The electronic controller 16 is also configured to send commands directly to the vehicle 4 to control at least one of the preconditioning of the vehicle battery, the charging of the vehicle battery, and the parking of the vehicle 4. For example, the electronic controller 16 is configured to control the battery management system of the vehicle 4 to precondition the battery based on the parking scores and/or the parking recommendation. The electronic controller 16 is also configured to control the vehicle 4 to charge the battery based on the parking scores and/or the parking recommendation. The electronic controller 16 can also be configured to control the vehicle 4 to perform auto-parking in the recommend parking spot or in the parking spot with the highest parking score among the parking spots 6a-6l.

The electronic controller 16 is also in communication with the vehicle 4 to collect real-time driving and parking data regarding the vehicle 4. For example, the electronic controller 16 is configured to receive information from the battery management system of the vehicle 4, temperature sensors of the vehicle 4, the telematics control unit of the vehicle 4, a camera of the vehicle 4, and the global positioning system (“GPS”) of the vehicle 4. The telematics control unit of the vehicle 4 aggregates the data from the temperature sensors, the GPS, the battery management system, and the camera and sends the data to the processors of the electronic controller 16. In this regard, the electronic controller 16 is configured to receive real-time information regarding the vehicle battery, such as the battery temperature or the state of charge, the location of the vehicle 4 and the environment of the vehicle 4, as well as historical information regarding the parking, usage and charging history of the vehicle 4. The electronic controller 16 is also in communication with the user terminal 18, for example via the internet.

The user terminal 18 can be any suitable external device that allows a user to view the parking scores and/or the recommended parking location, and to initiate the parking recommendation determination by the electronic controller 16. The user terminal 18 can be a cellular phone, a laptop or desktop computer, or any other personal electronic device with a graphical user interface (“GUI”) that allows a user to view the information that is displayed on the GUI. The user terminal 18 is preferably a cellular phone. The user terminal 18 can be located inside the vehicle 4 and/or remotely operated by a user of the vehicle 4.

The user terminal 18 is configured to allow a user to input a request to initiate a parking recommendation determination. For example, the electronic controller 16 can be configured to determine a parking recommendation based on the parking scores in response to a user input to the user terminal 18. Alternatively, the electronic controller 16 can be configured to display the parking scores for the parking spots 6a-6l on the user terminal 18, and the user can choose a preferred parking spot based on the displayed parking scores without receiving a recommended parking location from the electronic controller 16.

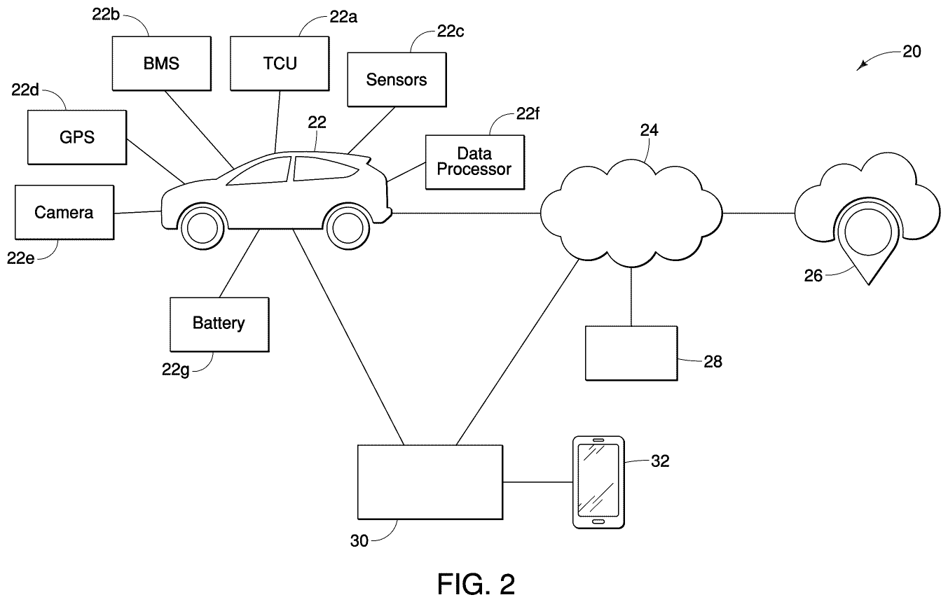

FIG. 2 shows a system 20 for managing a battery of a vehicle according to a second embodiment. The system 20 includes a vehicle 22, a cloud server 24, a geospatial and weather data server 26, a machine learning model 28, a controller 30, and a user terminal 32.

As shown in FIG. 2, the vehicle 22 includes a telematics control unit (“TCU”) 22a, a battery management system (“BMS”) 22b, sensors 22c, a GPS 22d, a camera 22e, a data processor 22f, and a battery 22g. The TCU 22a is configured to aggregate the data from BMS 22b, sensors 22c, GPS 22d, camera 22e and the battery 22g to obtain real-time information regarding the condition of the vehicle battery 22g, such as the state of charge or the battery health, the location of the vehicle 22, the usage of the vehicle 22, the parking information regarding the vehicle 22, and the surroundings of the vehicle 22. The TCU 22a is configured to send the aggregated data to the data processor 22f and/or the controller 30.

The BMS 22b monitors the state of the vehicle battery 22g and controls the charging, discharging and overall management of the battery 22g. For example, the BMS 22b monitors the state of charge of the battery 22g, as well as the temperature and the state of health of the battery. The BMS 22b is in wired or wireless communication with the vehicle 22 and the TCU 22a.

The sensors 22c include at least one sensor that detects conditions within or around the vehicle 22. For example, the sensors 22c include at least one temperature sensor configured to detect an external temperature in a vicinity of the vehicle 22, at least one temperature sensor configured to detect a temperature within the vehicle 22, an object sensor configured to detect external objects near the vehicle, and a vehicle speed sensor configured to detect a speed of the vehicle 22. The sensors 22c are in wired or wireless communication with the vehicle 22 and the TCU 22a.

The GPS 22d can be any suitable GPS that is configured to detect a current location of the vehicle 22. The camera 22e can include at least one camera and can be any suitable camera or cameras configured to capture images within the vehicle 22 or images of an area surrounding the vehicle 22. The GPS 22d and camera 22e are both in wired or wireless communication with the vehicle 22 and the TCU 22a.

The data processor 22f includes at least one data processor, for example, a central processing unit (“CPU”) or a micro-processing unit (“MPU”). The processors of the data processor 22f can be located at separate positions. For example, some of the processors can be provided in the vehicle 22, and the other processors can be provided in a remote server connected to the internet. When the processors are located at separate positions, the processors are connected to one another via a wireless communication device in a manner allowing for communication. The data processor 22f is in wired or wireless communication with the vehicle 22 and the TCU 22a.

The battery 22g is any suitable battery for an electric vehicle. For example, the battery 22g is any suitable battery that can be charged and discharged, such as a lithium-ion battery, a nickel-metal hydride battery, and a lead-acid battery. The battery 22g is preferably a lithium-ion battery. The battery 22g is in wired or wireless communication with the vehicle 22, the BMS 22b, and the TCU 22a.

The cloud server 24 is any server configured to transfer and store parking information regarding the vehicle 22, the geospatial and weather data server 26, and the machine learning model 28. For example, the cloud server 24 is in wired or wireless communication with the vehicle 22, the geospatial and weather data server 26, and the machine learning model 28. The cloud server 24 includes: a wired or wireless communication unit configured to transmit and receive parking information, and a memory configured to store the parking information.

The parking information includes information regarding a plurality of parking locations. The parking locations can be any suitable parking locations within a predetermined area of the vehicle 22, or a predetermined group of parking locations, such as frequently used parking locations for the vehicle 22. The parking information also includes historical data regarding the vehicle 22 and real-time data from the TCU 22a regarding the location, usage, and/or battery condition of the vehicle, parking conditions for the vehicle, and any other vehicle condition.

The parking information also includes information from the geospatial and weather data server 26 regarding each of the parking location. For example, the parking information from the server 26 includes information regarding the weather in an area near each of the parking locations, road maps for an area near each of the parking locations, information regarding land use or buildings in the area near each of the parking locations, satellite imagery of the area near each of the parking locations, locations of battery charging stations, and social media information regarding the area near the parking locations.

The parking information further includes information from the machine learning model 28 regarding the plurality of parking locations. For example, the following information can be input into the machine learning model: an ambient temperature near the vehicle 22, a battery temperature, a state of charge, a charging duration, charging power, a parking duration, GPS coordinates for the vehicle 22, a temperature difference between the ambient temperature and the battery temperature, weather data, historical parking scores 28 for the plurality of locations, information regarding the parking frequency for the vehicle 22 at the current location, behavior embedding from nearby or similar users, and inferred parking environment features (e.g., tree shading, garage, and direct sunlight exposure). The TCU 22a can be configured to send data regarding the vehicle 22 to processor 22f or controller 30 to perform feature extraction and imputation.

The machine learning model 28 then outputs the following information to the controller 30 to generate personalized recommendations and initiate automated actions such as smart preconditioning or charging: an updated parking score for the current parking session or location, a predicted range of future battery health for the vehicle 22, a feature importance or contribution, personalized parking recommendations and risk alerts for the vehicle 22 and/or user. These outputs update both local and distributed caches. The recommendations and risks alerts are provided to the user interfaces.

The controller 30 is any suitable electronic controller configured to communicate with the vehicle 22 and/or the cloud server 24 to determine the parking scores for the plurality of locations, and to further determine a recommended parking location for the vehicle 22, based on the information regarding the vehicle 22 and the parking information stored in the cloud server 24. For example, the controller 30 includes one or more processors that execute predetermined control programs to: determine or infer the type of parking environment (e.g., garage, driveway, street, etc.) for the parking locations, and determine or compute the parking score for each of the plurality of locations at a given time based on the inferred parking environment and the parking information.

The parking scores are determined based on the real-time sensor and environmental data from the vehicle 22 (e.g., from TCU 22a) and the parking information stored in the cloud server 24. For example, the parking scores for each of the plurality of locations at a given time are determined based on the temperature of the battery 22g, the external temperature of the area near the parking location, and other parking conditions such as the degree of sun exposure and proximity to a battery charging station. The parking scores are determined using rule-based logics or the machine learning model 28.

In this embodiment, the machine learning model 28 is separate from but in communication with the controller 30. However, it should be understood that the machine learning model 28 can alternatively be included in the controller 30 used to determine the parking scores for the plurality of locations. The controller 30 can also include a local memory or a local cache that can store a lookup table containing the parking scores for the plurality of locations. However, it should be understood that the lookup table containing the parking scores can alternatively be stored in the data processor 22f of the vehicle 22 or a cloud data processor, such as the cloud data server 24.

The controller 30 is configured to determine a recommended parking location from among the plurality of locations based on the parking scores. In particular, the controller 30 can be configured to generate base scores based on predefined rules regarding the environmental features of the locations. For example, if the type of parking environment is determined to be a garage, an average score, such as 50 or 75, can be adjusted by +10 points, and if the environment is determined to be an open shaded area, the score can be adjusted by +5 points, whereas street parking adjusts the score by −5 points, and extreme temperatures in the parking spots 6a-6l adjust the score by −15 points.

Then the controller 30 is configured to assign weights to each of the feature categories and combine the rule-based scores with the weighted adjustments to arrive at a final parking score. For example, the adjustment for parking type (e.g., garage, open shaded area, street parking) can be assigned a weight of 40%, the adjustment for temperature can be assigned a weight of 30%, and other factors can be assigned a weight of 30%. The controller 30 is configured to generate a parking score for each of the plurality of locations after each parking session by a user, and aggregate the parking scores over a period of time.

The recommended parking location for the vehicle 22 can be any suitable location depending on the condition of the vehicle 22 or a parking condition such as the parking score. For example, if the vehicle 22 has a low state of charge and needs to be charged while parking, the proximity to a charging station can be weighed more heavily in determining the recommended parking location. In contrast, if the battery 22g has a high temperature or a poor state of health, the parking score can be weighed more heavily in determining the recommended parking location.

The processors of the electronic controller 30 include, for example, a CPU or a MPU. The processors of the electronic controller 30 can be located at separate positions, with some of the processors being provided in the vehicle 30, the user terminal 32 or the cloud server 24, and the other processors being provided in a remote server connected to the internet. These processors are connected to one another via a wireless communication device to allow for communication. The electronic controller 30 can include one or more microcomputers. Thus, the term “electronic controller” as used herein refers to hardware that executes a software program, and does not include a human.

The electronic controller 30 is in communication with the vehicle 22, the cloud server 24 and the user terminal 32 via wired or wireless communication. For example, the electronic controller 30 can be located inside the vehicle 22 or can be located remotely from the vehicle 22 but in communication with the vehicle 22 and/or the user terminal 32, for example via the cloud server 24. The electronic controller 30 can include a communication unit in wired communication with the vehicle 22, the cloud server 24 and/or the user terminal 32. The electronic controller 30 is configured to send the parking scores and the parking recommendation to the user terminal 32. For example, the user terminal 32 can display the parking scores for each of the plurality of locations such that the user or driver can select the parking location for the vehicle 22.

The electronic controller 30 is also in communication with the vehicle 22 to collect real-time driving and parking data regarding the vehicle 22. For example, the electronic controller 30 is configured to receive information from the TCU 22a, the BMS 22b, the sensors 22c, the GPS 22d, the camera 22e, and data processor 22f of the vehicle 22. The TCU 22a aggregates the data from the BMS 22b, the sensors 22c, including at least one temperature sensor, the GPS 22d, and the camera 22e, and sends the data to the processors of the electronic controller 30. In this regard, the electronic controller 30 is configured to receive real-time information regarding the vehicle battery 22g, such as the battery temperature or the state of charge, the location of the vehicle 22 and the environment of the vehicle 22, as well as historical information regarding the parking, usage and charging history of the vehicle 22. The electronic controller 30 is also in communication with the user terminal 32, for example via the internet.

The electronic controller 30 is also configured to send commands directly to the vehicle 22 to control at least one of the preconditioning of the vehicle battery 22g, the charging of the vehicle battery 22g, and the parking of the vehicle 22. For example, the electronic controller 22 is configured to control the BMS 22b of the vehicle 22 to precondition the battery 22g based on the parking scores and/or the parking recommendation. The electronic controller 30 is also configured to control the vehicle 22 to charge the battery 22g based on the parking scores and/or the parking recommendation. The electronic controller 30 can also be configured to control the vehicle 22 to perform auto-parking in the recommend parking location or in the location with the highest parking score among the plurality of locations.

The user terminal 32 can be any suitable external device that allows a user to view the parking scores and/or the recommended parking location, and to initiate the parking recommendation determination by the electronic controller 30. The user terminal 32 can be a cellular phone, a laptop or desktop computer, or any other personal electronic device with a GUI that allows a user to view the information that is displayed on the GUI. The user terminal 32 is preferably a cellular phone. The user terminal 32 can be located inside the vehicle 22 and/or remotely operated by a user of the vehicle 22.

The user terminal 32 is configured to allow a user to input a request to initiate a parking recommendation to determine a recommended parking location. For example, the electronic controller 30 can be configured to determine a parking recommendation based on the parking scores in response to a user input to the user terminal 32. Alternatively, the electronic controller 30 can be configured to display the parking scores for the plurality of locations on the user terminal 32, and the user can choose a preferred parking spot based on the displayed parking scores without receiving a recommended parking location from the electronic controller 30.

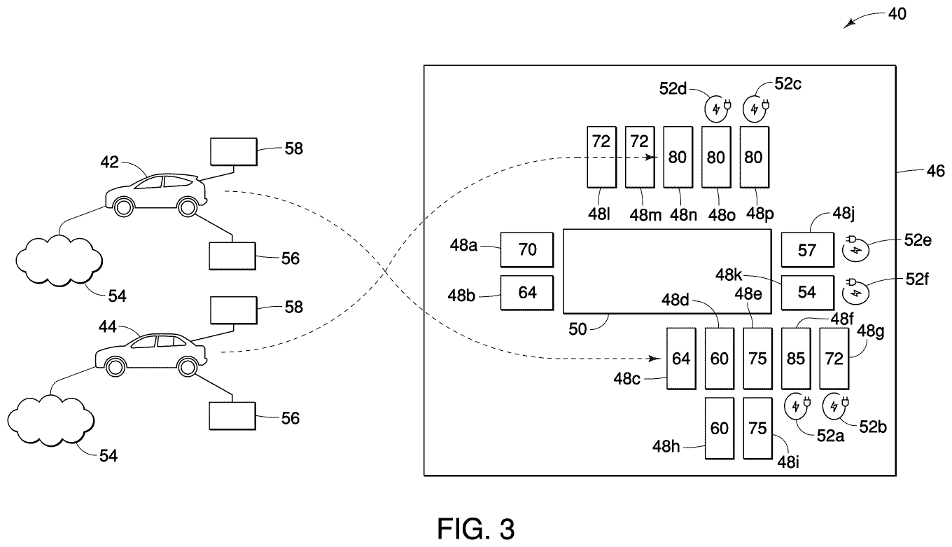

FIG. 3 shows a system 40 for providing a parking recommendation for a plurality of vehicles according to a second embodiment. The system 40 includes a first vehicle 42, a second vehicle 44, a parking lot 46, a plurality of parking spots 48a-48p, a building 50, a plurality of charging stations 52a-52f, a cloud server 54, a controller 56 and a user terminal 58.

The vehicles 42 and 44 are any suitable electric vehicles that include a battery and can be charged and discharged, such as a hybrid vehicle or a fully electric vehicle. Each of the vehicles 42 and 44 can include a bidirectional charging port that is configured to allow charging and discharging of the vehicles 42, 44. However, it should be understood that each of the vehicles 42 and 44 may alternatively include a unidirectional charging port that is configured to allow only charging of the vehicles 42, 44.

The vehicles 42 and 44 are rental vehicles. The first vehicle 42 is an economy EV that is more fuel-efficient and cost-effective for customers. In contrast, the second vehicle 44 is a luxury or premium EV that is more spacious or includes more features than an economy EV.

As shown in FIG. 3, the parking lot 46 includes a plurality of parking spots 48a-48n around the building 50. The parking spots 48a-48n are used by rental vehicles, including vehicles 42 and 44. Each of the parking spots 48a-48n includes a parking score represented by a number. A higher parking score represents a better or more desirable parking location for optimizing long-term battery health of the vehicles 42 and 44. For example, parking spots 48a and 48b are provided on the left side of the building 50 and have respective parking scores of 70 and 64. Parking spots 48c, 48d, 48e, 48f, 48g, 48h and 48i are provided on a bottom side of the building 50 and have respective parking scores of 64, 60, 75, 85, 72, 60 and 75. Parking spots 48j and 48k are provided on the right side of the building have the lowest parking scores of all the parking spots—54 and 57, respectively. Parking spots 48l, 48m, 48n, 48o and 48p are provided on the top side of the building 50 and have respective parking scores of 80, 80, 80, 72 and 72. Parking spots 48f, 48g, 48j, 48k, 48l and 48m are all located adjacent to charging stations (i.e., charging stations 52a, 52b, 52c, 52d, 52e and 52f, respectively). It should be understood that the parking scores for parking spots 48a-48n can vary depending on the time of day.

The building 50 is a rental office for renting vehicles including vehicles 42 and 44. However, it should be understood that the building 50 can be any suitable building connected to a power grid. For example, the building 50 can alternatively be an office building, a commercial building, a public building or a residential building. The building 50 is configured to draw power from the power grid to meet its energy demands. The building 50 is also configured to draw power from the power grid to supply power to the charging stations 52a-52f.

The charging stations 52a-52f each include bidirectional charging ports that are configured to supply power to and draw power from a vehicle connected thereto. In FIG. 3, six charging stations 52a, 52b, 52c, 52d, 52e and 52f are shown. However, it should be understood that any suitable number of charging stations can be provided in the system 40. Alternatively, the charging stations 52a, 52b, 52c, 52d, 52e and 52f can be unidirectional charging ports that are only configured to supply power to a vehicle connected thereto.

The cloud server 54 is any server configured to transfer and store information regarding the parking spots 48a-48p. For example, the cloud server 54 includes: a wired or wireless communication unit configured to transmit and receive parking information, and a memory configured to store the parking information. The parking information includes information regarding the parking scores for the parking spots 48a-48p, as well as parking scores for other parking locations. The parking information also includes historical data regarding the vehicles 42 and 44, such as information from a telematics control unit of the each of the vehicles regarding the location, usage, and/or battery condition of the vehicle, parking conditions for the vehicle, and any other vehicle condition. The parking information also includes information from online weather and geospatial data services, and information from a machine learning model regarding the parking spots 48a-48p.

The controller 56 is any suitable electronic controller configured to communicate with the vehicles 42, 44 and/or the cloud server 54 to determine or acquire the parking scores for the parking spots 48a-48p and to further determine a recommended parking location for the each of the vehicles 42, 44 based on the parking information stored in the cloud server 54. For example, the controller 56 includes one or more processors that execute predetermined control programs to: determine or infer the type of parking environment for the parking spots 48a-48p, and determine or compute the parking score for each of the parking spots 48a-48p based on the inferred parking environment and real-time sensor and environmental data, such as the battery temperature of each of the vehicles 42 and 44, the external temperature of the parking spots 48a-48p, and other parking conditions such as the degree of sun exposure or the proximity to a charging station, using rule-based logics or machine learning model(s). Alternatively, the controller 56 is configured to acquire the parking scores from the cloud server 54 or the vehicles 42, 44.

The controller 56 can also include the machine learning model(s) used to determine the parking scores for the parking spots 48a-48p. However, it should be understood that the machine learning model(s) can alternatively be located externally to the controller 56 but in communication with the controller 56. The controller 56 can also include a local memory or a local cache that can store a lookup table containing the parking scores for the parking spots 48a-48p. However, it should be understood that the lookup table containing the parking scores can alternatively be stored in a local data processor for the vehicles 42 and 44 or a cloud data processor, such as the cloud data server 54.

The controller 56 is configured to determine a recommended parking location for each of the vehicles 42 and 44 from among the parking spots 48a-48p based on the parking scores and other parking information. In particular, the controller 56 can be configured to generate base scores based on predefined rules regarding the environmental features of the parking spots 48a-48p. For example, if the type of parking environment is determined to be a garage, an average score, such as 50 or 75, can be adjusted by +10 points, and if the environment is determined to be an open shaded area, the score can be adjusted by +5 points, whereas street parking adjusts the score by-5 points, and extreme temperatures in the parking spots 48a-48p adjust the score by-15 points.

Then the controller 56 is configured to assign weights to each of the feature categories and combine the rule-based scores with the weighted adjustments to arrive at a final parking score. For example, the adjustment for parking type (e.g., garage, open shaded area, street parking) can be assigned a weight of 40%, the adjustment for temperature can be assigned a weight of 30%, and other factors can be assigned a weight of 30%. The controller 56 is configured to generate a score for each of the parking spots 48a-48p for each parking session by a user, and aggregate the parking scores over a period of time.

In FIG. 3, the recommended parking location for the first vehicle 42 is parking spot 48c. Although this parking location has a lower parking score than other locations in the parking lot 46, spot 48c is located relatively close to the entrance to the lot 46 and is also relatively close to a charging station 52a. These features are likely more desirable for an economy EV such as the first vehicle 42. In contrast, the recommended parking location for the second vehicle 44, which is a luxury or premium EV, is parking spot 48l. This parking location has one of the highest parking scores in the lot 46 and is located very close to charging station 52d. These features are likely more desirable and important for a luxury EV such as the second vehicle 44. It should be understood that the recommended parking location for the first vehicle 42 or the second vehicle 44, or any other vehicle associated with the rental office 50, can be any suitable location depending on the condition of the vehicle 42 or 44, the proximity to a charging station, or the parking score.

The processors of the electronic controller 56 include, for example, a CPU or a MPU. The processors of the electronic controller 56 can be located at separate positions, with some of the processors being provided in the vehicles 42 and/or 44, the building 50, the user terminal 58 and/or the cloud server 54, and the other processors being provided in a remote server connected to the internet. When the processors are located at separate positions, the processors are connected to one another via a wireless communication device in a manner allowing for communication. The electronic controller 56 can include one or more microcomputers. Thus, the term “electronic controller” as used herein refers to hardware that executes a software program, and does not include a human.

The electronic controller 56 is in communication with the vehicles 42 and 44, the cloud server 54 and the user terminal 58 via wired or wireless communication. For example, the electronic controller 56 can be located inside one of the vehicles 42 or 44 or can be located remotely from the vehicle 42 or 44 but in communication with the vehicles 42 and 44 and/or the user terminal 58, for example via the cloud server 54. The electronic controller 56 can include a communication unit in wired communication with the vehicles 42 and 44 and/or the user terminal 58. The electronic controller 56 is configured to send the parking scores and the parking recommendation to the user terminal 58. For example, the user terminal 58 can display the parking scores for each of the parking spots 48a-48p such that the user or rental office manager can select the parking locations for the vehicles 42 and 44.

The electronic controller 56 is also configured to send commands directly to the vehicles 42 and 44 to control at least one of the preconditioning of the vehicle batteries, the charging of the vehicle batteries, and the parking of the vehicles 42 and 44. For example, the electronic controller 56 is configured to control the battery management system of the vehicles 42 and 44 to precondition the batteries based on the parking scores and/or the parking recommendation for each vehicle. The electronic controller 56 is also configured to control the vehicles 42 and 44 to charge the batteries of the vehicles based on the parking scores and/or the parking recommendations. The electronic controller 56 can also be configured to control the vehicles 42 and 44 to perform auto-parking in the recommend parking spots.

The electronic controller 56 is also in communication with the vehicles 42 and 44 to collect real-time driving and parking data regarding the vehicles 42 and 44. For example, the electronic controller 56 is configured to receive information from the battery management system of each of the vehicles 42 and 44, temperature sensors of the vehicles 42 and 44, the telematics control unit of each of the vehicles 42 and 44, a camera of each of the vehicles 42 and 44, and the GPS of the vehicles 42 and 44. The telematics control unit of each of the vehicles 42 and 44 aggregates the data from the temperature sensors, the GPS, the battery management system, and the camera and sends the data to the processors of the electronic controller 56. In this regard, the electronic controller 56 is configured to receive real-time information regarding the vehicle batteries, such as the battery temperature or the state of charge for the battery of each of the vehicles 42 and 44, the locations of the vehicles 42 and 44 and the environments of the vehicles 42 and 44, as well as historical information regarding the parking, usage and charging history of each of the vehicles 42 and 44. The electronic controller 56 is also in communication with the user terminal 58, for example via the internet.

The user terminal 58 can be any suitable external device that allows a user to view the parking scores and/or the recommended parking locations, and to initiate the parking recommendation determinations by the electronic controller 56. The user terminal 58 can be a cellular phone, a laptop or desktop computer, or any other personal electronic device with a GUI that allows a user to view the information displayed on the GUI. The user terminal 58 is preferably a cellular phone. The user terminal 58 can be located inside one of the vehicles 42 or 44 and/or remotely operated by a user/manager of the vehicles 42, 44.

The user terminal 58 is configured to allow a user to input a request to initiate a parking recommendation to determine a recommended parking location for one or both of the vehicles 42 and 44. For example, the electronic controller 56 can be configured to determine a parking recommendation based on the parking scores in response to a user input to the user terminal 58. Alternatively, the electronic controller 56 can be configured to display the parking scores for the parking spots 48a-48p on the user terminal 58, and the user or manager of the vehicles 42 and 44 can choose a preferred parking spot for each of the vehicles based on the displayed parking scores without receiving a recommended parking location from the electronic controller 56.

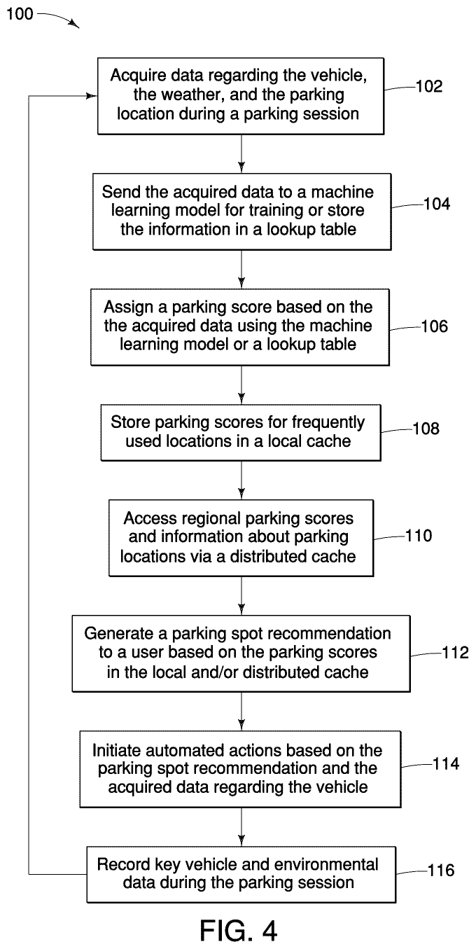

FIG. 4 shows a process 100 of managing the battery of a vehicle in accordance with a fourth embodiment. The vehicle is any suitable electric vehicle that includes a battery and can be charged and discharged, such as a hybrid vehicle or a fully electric vehicle. The vehicle can include a bidirectional charging port that is configured to allow charging and discharging of the vehicle. However, it should be understood that the vehicle may alternatively include a unidirectional charging port that is configured to allow only charging of the vehicle. The process 100 can be implemented by a processor such as a CPU or an MPU, and the processor can be included in an electronic controller.

In Step 102, the processor acquires data regarding the vehicle, the weather and the parking location during a parking session. The vehicle data includes information regarding a condition of the vehicle or the vehicle battery, such as information from a TCU of the vehicle regarding the location, usage, and/or battery condition of the vehicle, parking conditions for the vehicle, and any other vehicle condition or historical information regarding the vehicle. For example, the processor collects and integrates data from a BMS of the vehicle, sensors (e.g., temperature sensors) of the vehicle, a GPS of the vehicle, the TCU, a camera of the vehicle, a data processor of the vehicle and an external weather application programming interface in the vehicle. The sensors and GPS collect real-time driving and parking data for the vehicle, such as information about a parking session and battery health. The TCU aggregates this real-time data and sends it to the data processor. The data is then enriched with external weather and parking location data from weather and geospatial services regarding the parking location.

The weather and parking location data includes information from online weather and geospatial data services regarding an area around the parking location. For example, the weather and parking location data includes information regarding the external temperature at the parking location, road maps for an area near the parking location, information regarding land use or buildings in the area near the parking location, satellite imagery of the area near the parking location, locations of battery charging stations in an area near the parking location, and social media information regarding the area near the parking location. The information regarding the parking location also includes feedback from a user regarding the parking location.

The processor then sends the acquired data to a machine learning model or stores the information in a lookup table in Step 104. For example, the data regarding the vehicle, the weather and the parking location during a parking session is used by the processor to perform feature extraction and imputation. Once the feature extraction and imputation has been performed, the output from the processor is fed into a machine learning model to train the model or is stored in a lookup table in a local memory or a local cache of a user terminal or the processor for later determination of parking scores.

In Step 106, the processor assigns a parking score to the parking location based on the acquired data using the machine learning model or the lookup table. For example, the processor determines or infers the type of parking environment (e.g., garage, driveway, street, etc.) for the parking location. The process then determines or computes the parking score for the parking location based on the inferred parking environment and the acquired data, including real-time sensor and environmental data such as the battery temperature of the vehicle, the external temperature of the parking location, and other parking conditions such as the degree of sun exposure or the proximity of the parking location to a charging station. The processor uses the machine learning model, or rule-based logics and the information from the lookup table, to determine a parking score.

For example, the processor generates a base score for the parking location based on predefined rules regarding the environmental features of the location. For example, if the type of parking environment is determined to be a garage, an average score, such as 50 or 75, can be adjusted by +10 points, and if the environment is determined to be an open shaded area, the score can be adjusted by +5 points, whereas street parking adjusts the score by −5 points, and extreme temperatures in the parking spots 6a-6l adjust the score by −15 points.

The processor then assigns weights to each of the feature categories and combines the rule-based scores with the weighted adjustments to arrive at a final parking score. For example, the adjustment for parking type (e.g., garage, open shaded area, street parking) can be assigned a weight of 40%, the adjustment for temperature can be assigned a weight of 30%, and other factors can be assigned a weight of 30%. The processor generates a score for the parking location for each parking session by a user, and aggregates the parking scores over a period of time. For example, if the user parked in an unshaded location exposed to the sun, the processor could send a message saying “you parked in the direct sun” to the user when assigning a parking score.

In Step 108, the parking scores for locations frequently used by the user(s) of the vehicle are stored in a local cache or a local memory. The local cache or memory can be located in the processor, the vehicle, a user terminal or a cloud data processor. For example, a lookup table containing the parking scores for frequently used locations of the vehicle can be stored in the local cache or local memory. When new parking score information for a location becomes available, the processor confirms whether the location is frequently used and caches the parking score locally to enable faster inference in the future.

The processor also accesses regional parking scores and information about various parking locations via a distributed cache in Step 110. For example, the processor accesses a cloud data server to obtain aggregated parking scores and behaviors from similar users or vehicles or nearby locations to enrich the data stored in the local cache or local memory. The use of a distributed cache to access additional parking scores beyond those stored locally is especially useful for unfamiliar or new parking locations.

The processor then generates a parking spot recommendation for a user in Step 112 based on the parking scores stored in the local cache or the distributed cache. For example, the processor can determine a recommended parking spot from among the parking locations for which there are parking scores by choosing the parking location with the highest parking score, the parking location closest to the current location of the vehicle, the parking location that is closest to a charging station, or by weighing the parking score, the proximity of the parking location to the current vehicle location, and the proximity of the parking location to a charging station and determining the parking location that achieves the desired balance of those variables.

In particular, the processor can be configured to generate base scores based on predefined rules regarding the environmental features of the parking locations. For example, if the type of parking environment is determined to be a garage, an average score can be adjusted by +10 points, and if the environment is determined to be an open shaded area, the score can be adjusted by +5 points, whereas street parking adjusts the score by −5 points, and extreme temperatures in the parking locations adjust the score by −15 points.

The processor can also be configured to assign weights to each of the feature categories and combine the rule-based scores with the weighted adjustments to arrive at a final parking score. For example, the adjustment for parking type (e.g., garage, open shaded area, street parking) can be assigned a weight of 40%, the adjustment for temperature can be assigned a weight of 30%, and other factors can be assigned a weight of 30%. The processor is configured to generate a score for each of the parking locations for each parking session by a user, and aggregate the parking scores over a period of time. The parking spot recommendation can be a recommendation to choose a particular location, or any suitable location among a plurality of locations, depending on the condition of the vehicle, the proximity to a charging station, or the parking score for those locations.

The processor can also communicate with a user terminal to display the parking spot recommendation(s) and receive user feedback regarding the parking spot recommendation(s). The aggregated parking scores can be updated based on the user feedback regarding the parking spot recommendation(s) or any recommended parking location(s). The processor can also utilize local and regional parking data to generate custom parking recommendations and suggestions for the user, which are displayed via a GUI on the user terminal or via the user interface of the vehicle.

In Step 114, the processor initiates automated actions based on the parking spot recommendation. For example, the processor send commands directly to the vehicle to control the preconditioning of the vehicle battery, the charging of the vehicle battery, and/or the parking of the vehicle. For example, the processor is configured to control the BMS of the vehicle to precondition the battery based on the parking scores and/or the parking spot recommendation. The processor is also configured to control the charging of the vehicle battery based on the parking scores and/or the parking spot recommendation. The processor is also configured to control the vehicle to perform auto-parking in the recommend parking spot or in a selected parking spot based on the parking spot recommendation.

During or within a predetermined time after the parking session, key vehicle and environmental data regarding the parking location is recorded in Step 116. The key vehicle and environmental data is then stored either locally or in a cloud server to support future updates to a machine learning model, behavioral analysis, and feedback learning regarding the parking locations. The data is recorded using a data logger, the BMS or TCU of the vehicle, a cloud server, or local storage such as storage in the vehicle or a user terminal. After Step 116, the process 100 is repeated beginning with Step 102.

By providing a process in which a parking recommendation for a vehicle is made based on information regarding the vehicle battery, a weather condition near the parking location, and geospatial information regarding an area around the parking location, the long-term battery health of the vehicle can be improved. In particular, by providing parking scores and a parking recommendation for the vehicle, the health of the vehicle battery can be improved by taking into consideration parking conditions such as external temperature and environmental conditions and either automatically parking the vehicle in a recommended parking location or recommending an optimal parking location for the vehicle to a user.

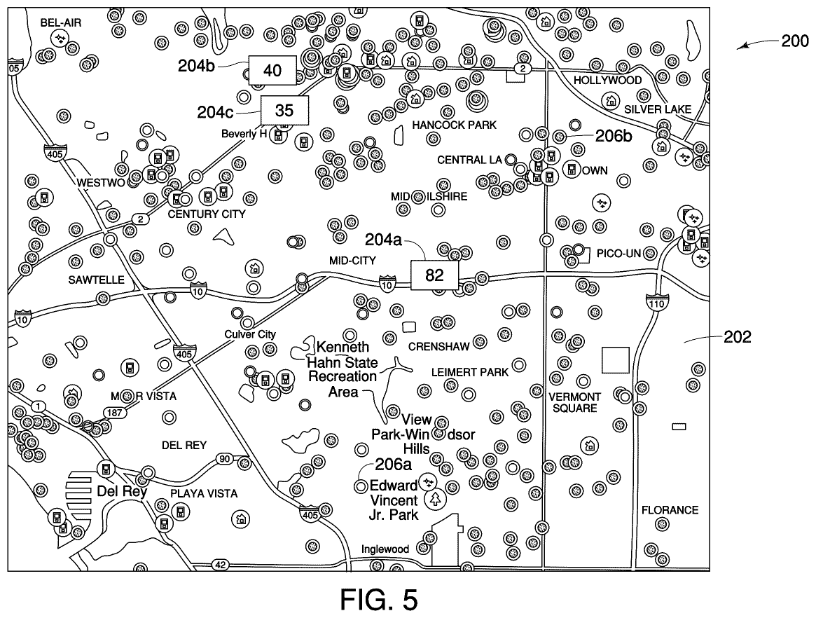

FIG. 5 is a chart 200 showing parking scores for various parking locations in an area on a map according to a fifth embodiment. The map 202 is a map of an area of California near Century City. However, it should be understood that the map 202 can be a map of any suitable area that includes parking locations for EVs. The chart 200 shows parking scores 204a, 204b and 204c. Each of the parking scores 204a, 204b and 204c corresponds to one of the plurality of parking locations represented by circles on the map 202. The parking locations include locations 206a and 206b. The map 202 can be displayed on a GUI or other suitable user interface to show a user of an EV parking scores for nearby locations. The user can then decide where to park based on the parking scores, or the EV can be automatically controlled based on the parking scores 204a-204c.

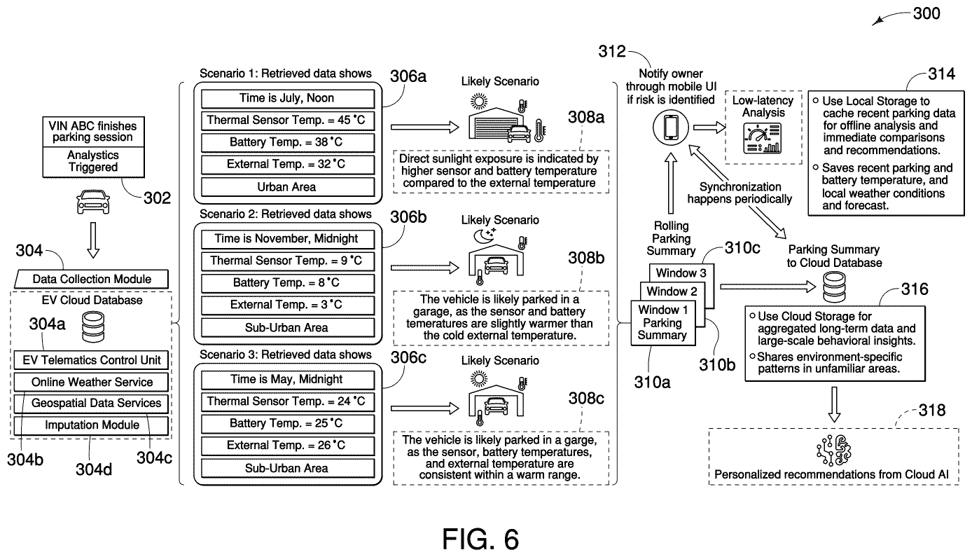

FIG. 6 shows a process 300 of managing the battery of a vehicle according to a sixth embodiment. The vehicle is any suitable EV that includes a battery that can be charged, such as a hybrid vehicle or a fully electric vehicle. The vehicle can include a bidirectional charging port that is configured to allow charging and discharging of the vehicle, or a unidirectional charging port that is configured to allow only charging of the vehicle. The process 300 can be implemented by a processor such as a CPU or an MPU, and the processor can be included in an electronic controller.

In Step 302, analytics are triggered after a parking session is finished for a vehicle ABC. In particular, after a parking session is finished, a controller within or external to the vehicle ABC sends a signal to a cloud server to retrieve data regarding the vehicle and the parking location for the parking session.

As shown in Step 304, data regarding the vehicle and the parking location is retrieved in a data collection module. The data collection module includes an EV cloud database that can receive and store parking information for the vehicle. For example, the EV cloud database can be a cloud server that includes: a wired or wireless communication unit configured to transmit and receive the parking information, and a memory configured to store the parking information. The EV cloud database is in wired or wireless communication with, and is configured to transfer and store parking information from, TCU 304a, an online weather service 304b, a geospatial data service 304c, and an imputation module 304d. The parking information includes information regarding a plurality of parking locations. The parking locations can be any suitable parking locations within a predetermined area of the EV, or a predetermined group of parking locations, such as frequently used parking locations for the EV.

In Step 304, vehicle data is retrieved from TCU 304a regarding the location, usage, and/or battery condition of the EV, parking conditions for the EV, and any other vehicle condition or historical information regarding the EV. For example, the processor collects and integrates data from a BMS of the EV, sensors (e.g., temperature sensors) of the EV, a GPS of the EV, the TCU 304a, a camera of the EV, a data processor of the EV and an external weather application programming interface in the EV. The sensors and GPS collect real-time driving and parking data for the EV, such as information about a parking session and battery health, and the TCU 304a aggregates this real-time data.

Data regarding the parking location is retrieved from the online weather service 304b and the geospatial data service 304c. For example, the data from the online weather service 304b includes information regarding the weather in an area near the parking location. The data from the geospatial data service 304c includes road maps for an area near the parking location, information regarding land use or buildings in the area near the parking location, satellite imagery of the area near the parking location, locations of battery charging stations, and social media information regarding the area near the parking location.

The imputation module 304d is a processor such as a CPU or an MPU, and the processor can be included in an electronic controller. The imputation module 304d is configured to replace or fill in missing geospatial or weather information for the parking location from the online weather service 304b and/or the geospatial data service 304c based on other information for nearby locations. The imputation module 304d also helps determine the complete state of charge profile for the parking session based on original state of charge/charging parameters, such as the start and end state of charge, the duration of charging, the charge power, etc. The imputation module 304d is also configured to consider the typical patterns for the detected charge type (e.g., fast vs. normal charging overnight) or vehicle-to-grid specifications. Based on this information, the imputation module 304d can impute battery temperature profiles if the information is only available at sparse intervals, for example by relying on physical models or historical patterns. The imputation module 304d thus also calculates temperature differences from different sensors at a higher resolution. If the ambient or battery temperature is only available at the start and end of a vehicle trip, the interpolated temperature differences can improve understanding of the parking environment type and related thermal stress.

Based on the data obtained in Step 304, retrieved data is compiled for three different parking session scenarios in Steps 306a, 306b and 306c. For example, in Step 306a, Scenario 1 shows retrieved data for a first parking location during a time of noon in the month of July. The retrieved data in Scenario 1 shows that the parking session occurred in an urban area and the thermal sensor, battery and external temperatures during the parking session were all relatively high-above 30 °C. In contrast, in Step 306b, Scenario 2 shows retrieved data for a second parking location during a time of midnight in the month of November. The parking session in Scenario 2 occurred in a sub-urban area in relatively low thermal sensor, battery and external temperatures of less than 10 °C. In Step 306c, Scenario 3 shows retrieved data for a third parking location during a time of midnight in the month of May. The retrieved data in Scenario 3 shows that the parking session occurred in a sub-urban area and the thermal sensor, battery and external temperatures during the parking session were all between 24 °C and 26 °C

In Steps 308a-308c, the parking conditions during the respective parking session scenarios are inferred based on the retrieved data from Steps 306a, 306b and 306c. For example, in Step 308a, the processor determines that the EV was exposed to direct sunlight during the Scenario 1 parking session, because the sensor and battery temperatures were higher than the external temperature. In Step 308b, the processor determines that the EV was likely parked in a garage during the Scenario 2 parking session, because the sensor and battery temperatures are slightly higher than the cold external temperature. The processor determines in Step 308c that the EV was likely parked in a garage, because the sensor, battery temperatures, and external temperatures are all consistent within a warm range. The inferred parking conditions in Steps 308a-308c can optionally be displayed to a GUI on an external device or a user interface in the EV.

Windows summarizing the three parking sessions in Scenarios 1-3 are provided in Step 310. In Step 312, an owner or user of the EV is notified, via the GUI on the external device or the user interface in the EV, if a risk to battery health is identified.

In Step 314, local storage or memory is used to cache recent parking data for offline analysis and immediate comparisons and recommendations. For example, recent parking and battery temperatures can be saved in local storage, as well as local weather conditions and forecasts regarding future local weather conditions.

In Step 316, the parking summaries from Step 310 are sent to the EV cloud database. The cloud database aggregates long-term parking data and large-scale behavioral insights. In this manner, environment-specific patterns in unfamiliar/new areas can be shared between different EVs and/or users.

The EV cloud database includes a processor that generates personalized parking spot recommendations for users using an artificial intelligence model in Step 318. The parking spot recommendations are based on the parking scores stored in the local cache and/or the EV cloud database. For example, the processor can determine a recommended parking spot from among a group of the parking locations for which there are parking scores by choosing the parking location with the highest parking score, the parking location closest to the current location of the vehicle, the parking location that is closest to a charging station, or by weighing the parking scores, proximity to the vehicle and proximity to a charging station and determining the location that achieves the desired balance of those variables.

In particular, the processor can be configured to generate base scores based on predefined rules regarding the environmental features of the parking locations. For example, if the type of parking environment is determined to be a garage, an average score can be adjusted by +10 points, and if the environment is determined to be an open shaded area, the score can be adjusted by +5 points, whereas street parking adjusts the score by −5 points, and extreme temperatures in the parking locations adjust the score by −15 points.

The processor can also be configured to assign weights to each of the feature categories and combine the rule-based scores with the weighted adjustments to arrive at a final parking score. For example, the adjustment for parking type (e.g., garage, open shaded area, street parking) can be assigned a weight of 40%, the adjustment for temperature can be assigned a weight of 30%, and other factors can be assigned a weight of 30%. The processor is configured to generate a score for each of the parking locations for each parking session by a user, and aggregate the parking scores over a period of time. The parking spot recommendation can be a recommendation to choose a particular location, or any suitable location among a plurality of locations, based on the parking scores and other conditions.

The processor can also communicate with a user terminal to display the parking spot recommendation(s) and receive user feedback regarding the parking spot recommendation(s). The aggregated parking scores can be updated based on the user feedback regarding the parking spot recommendation(s) or any recommended parking location(s). The processor can also utilize local and regional parking data to generate custom parking recommendations and suggestions for the user, which are displayed via a GUI on the user terminal or via the user interface of the vehicle.

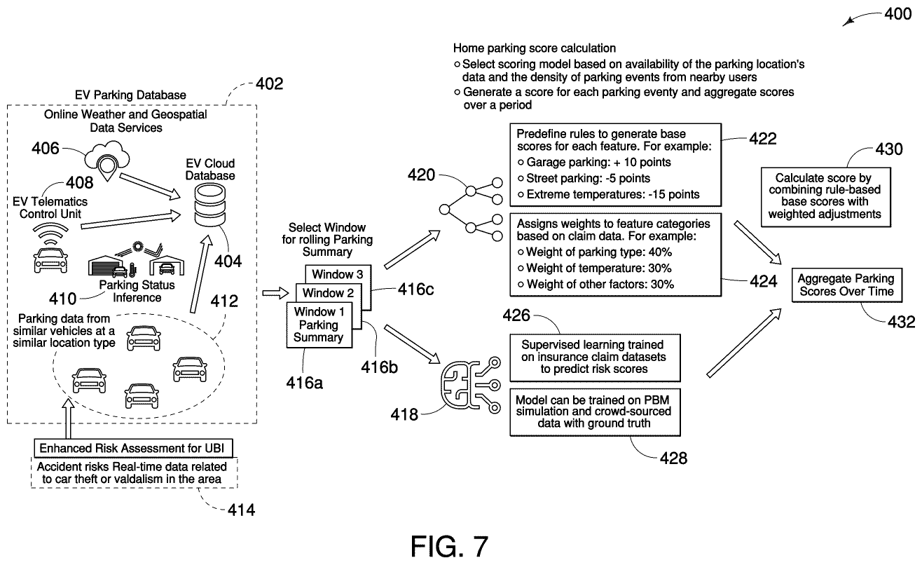

FIG. 7 shows a process 400 of managing the battery of a vehicle in accordance with a seventh embodiment. The vehicle is any suitable electric vehicle that includes a battery and can be charged and discharged, such as a hybrid vehicle or a fully electric vehicle. The vehicle can include a bidirectional charging port that is configured to allow charging and discharging of the vehicle or a unidirectional charging port that is configured to allow only charging of the vehicle. The process 400 can be implemented by a processor such as a CPU or an MPU, and the processor can be included in an electronic controller.

In Step 402, data regarding the vehicle and the parking location is retrieved in an EV parking database. The EV parking database includes an EV cloud database 404 that can receive and store parking information for the EV. For example, the EV cloud database 404 can be a cloud server that includes: a wired or wireless communication unit configured to transmit and receive the parking information, and a memory configured to store the parking information. The EV cloud database is in wired or wireless communication with, and is configured to transfer and store parking information from, an online weather and geospatial data service 406, a TCU 408 of an EV, a parking status inference module 410, and a distributed cache 412 that stores parking data for similar vehicles at similar locations. The parking information includes information regarding a plurality of parking locations. The parking locations can be any suitable parking locations within a predetermined area of the EV, or a predetermined group of parking locations.

Data regarding the parking location is retrieved from the online weather and geospatial data service 406. The data from the online service 406 includes information regarding the weather in an area near the parking location, road maps for an area near the parking location, information regarding land use or buildings in the area near the parking location, satellite imagery of the area near the parking location, locations of battery charging stations, and social media information regarding the area near the parking location.

Vehicle data is retrieved from TCU 408 regarding the location, usage, and/or battery condition of the EV, parking conditions for the EV, and any other vehicle condition or historical information regarding the EV. For example, the processor collects and integrates data from a BMS of the EV, sensors (e.g., temperature sensors) of the EV, a GPS of the EV, the TCU 408, a camera of the EV, a data processor of the EV and an external weather application programming interface in the EV. The sensors and GPS collect real-time driving and parking data for the EV, such as information about a parking session and battery health, and the TCU 408 aggregates this real-time data.

The parking status inference module 410 is a processor such as a CPU or an MPU, and the processor can be included in an electronic controller. The parking status inference module 410 is configured to infer parking conditions during a respective parking session based on the data retrieved for that parking session from the online weather and geospatial data service 406 and the TCU 408. For example, the processor determines whether the EV was parked in a garage or in a location exposed to direct sunlight based on whether the sensor and battery temperatures were higher than the external temperature, and whether the temperatures were relatively high or low. The inferred parking conditions in module 410 can optionally be displayed to a GUI on an external device or a user interface in the EV.

The processor also accesses regional parking scores and information about various parking locations via a distributed cache 412. For example, the processor accesses a cloud data server to obtain aggregated parking scores and behaviors from similar users or vehicles or nearby locations to enrich the data stored in the local cache or local memory. The use of the distributed cache 412 to access additional parking scores beyond those stored locally is especially useful for unfamiliar or new parking locations.

In Step 414, a processor is configured to determine accident risks based on real-time data related to car theft or vandalism in a predetermined area around the parking location. The risk assessment determination can be used to determine usage-based insurance premiums for the EV. The risk assessment determination is sent to the EV parking database and stored as part of the parking information.

Three windows including parking summaries for parking sessions are provided in Steps 416a, 416b and 416c. The windows can be displayed to a user via a GUI on an external device or via a user interface in the EV so the user can select one of the windows.

The processor then sends the parking summaries of Steps 416a, 416b and 416c to a machine learning model in Step 418 or a lookup table in Step 420. Prior to Steps 418 and 420, the data regarding the vehicle, the weather and the parking location during a parking session can be used by the processor to perform feature extraction and imputation. Once the feature extraction and imputation has been performed, the output from the processor is fed into the machine learning model in Step 418 to train the model or is stored in a lookup table in Step 420 for later determination of parking scores.

In Step 422, the information from the lookup table is used to generate base scores based on predefined rules regarding the environmental features of the parking locations. For example, if the type of parking environment is determined to be a garage, an average score can be adjusted by +10 points, and if the environment is determined to be an open shaded area, the score can be adjusted by +5 points, whereas street parking adjusts the score by −5 points, and extreme temperatures in the parking locations adjust the score by −15 points.

As shown in FIG. 7, the processor assigns weights to each of the feature categories. For example, the adjustment for parking type (e.g., garage, open shaded area, street parking) can be assigned a weight of 40%, the adjustment for temperature can be assigned a weight of 30%, and other factors can be assigned a weight of 30%.

In Step 426, the machine learning model is trained with supervised learning using insurance claim datasets to predict risk scores. The model can be trained on population balance model simulation and crowd-sourced data with ground truth data.

The rule-based scores from Step 422 are combined with the weighted adjustments from Step 424 to generate a final parking score in Step 430 for each of the parking locations for each parking session by a user. In Step 432, the processor is configured to aggregate the parking scores over a period of time. The aggregated parking scores can then be used to generate a parking spot recommendation(s).

The processor can also communicate with a user terminal to display the parking spot recommendation(s) and receive user feedback regarding the parking spot recommendation(s). The aggregated parking scores can be updated based on the user feedback regarding the parking spot recommendation(s) or any recommended parking location(s). The processor can also utilize local and regional parking data to generate custom parking recommendations and suggestions for the user, which are displayed via a GUI on the user terminal or via the user interface of the vehicle.

By providing a process in which parking recommendations for a vehicle is made based on information regarding the vehicle battery, a weather condition near the parking location, and geospatial information regarding an area around the parking location, the long-term battery health of the vehicle can be improved. In particular, by providing parking scores and parking recommendations for the vehicle, the health of the vehicle battery can be improved by taking into consideration parking conditions such as external temperature and environmental conditions and either automatically parking the vehicle in a recommended parking location or recommending an optimal parking location for the vehicle to a user.

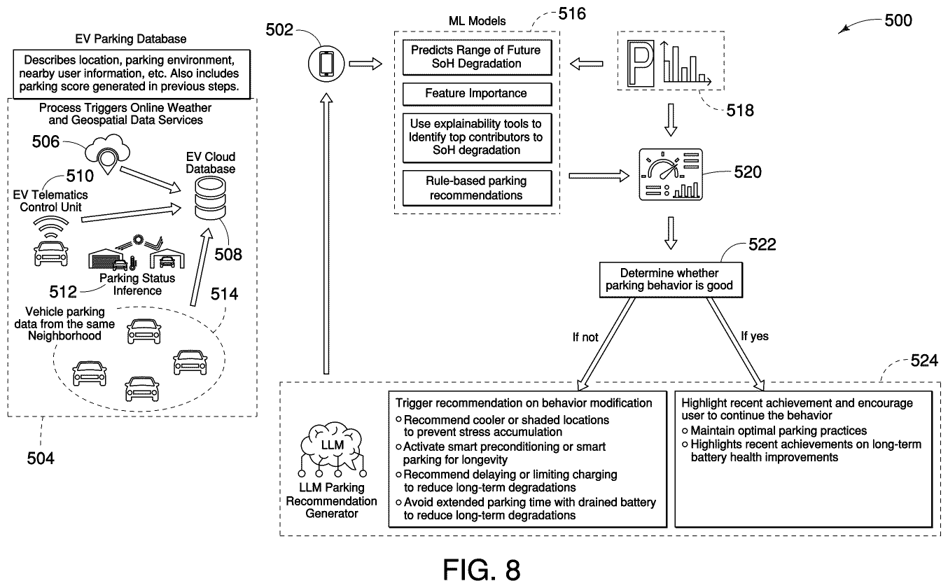

FIG. 8 shows a process 500 of managing the battery of a vehicle in accordance with an eighth embodiment. The vehicle is any suitable electric vehicle that includes a battery and can be charged and discharged, such as a hybrid vehicle or a fully electric vehicle. The vehicle can include a bidirectional charging port that is configured to allow charging and discharging of the vehicle. However, it should be understood that the vehicle may alternatively include a unidirectional charging port that is configured to allow only charging of the vehicle. The process 500 can be implemented by a processor such as a CPU or an MPU, and the processor can be included in an electronic controller.

In Step 502, a user terminal acquires information from an EV cloud database. The user terminal can be any suitable external device that allows a user to view parking information and to initiate a parking recommendation determination. For example, the user terminal can be a cellular phone, a laptop or desktop computer, or any other personal electronic device with a GUI that allows a user to view the information that is displayed on the GUI. The user terminal is preferably a cellular phone. The user terminal can be located inside the vehicle and/or remotely operated by a user of the vehicle.

Data regarding the vehicle and the parking location is retrieved in an EV parking database in Step 504. The EV parking database includes an EV cloud database 508 that can receive and store parking information for the EV. For example, the EV cloud database 508 can be a cloud server that includes: a wired or wireless communication unit configured to transmit and receive the parking information, and a memory configured to store the parking information. The EV cloud database is in wired or wireless communication with, and is configured to transfer and store parking information from, an online weather and geospatial data service 506, a TCU 510 of the EV, a parking status inference module 512, and a distributed cache 514 that stores parking data for similar vehicles at similar locations.

Data regarding the parking location is retrieved from the online weather and geospatial data service 506. The data from the online service 506 includes information regarding the weather in an area near the parking location, road maps for an area near the parking location, information regarding land use or buildings in the area near the parking location, satellite imagery of the area near the parking location, locations of battery charging stations, and social media information regarding the area near the parking location.

Vehicle data is retrieved from TCU 510 regarding the location, usage, and/or battery condition of the EV, parking conditions for the EV, and any other vehicle condition or historical information regarding the EV. For example, the processor collects and integrates data from a BMS of the EV, sensors (e.g., temperature sensors) of the EV, a GPS of the EV, the TCU 408, a camera of the EV, a data processor of the EV and an external weather application programming interface in the EV. The sensors and GPS collect real-time driving and parking data for the EV, such as information about a parking session and battery health, and the TCU 408 aggregates this real-time data.

The parking status inference module 512 is a processor such as a CPU or an MPU, and the processor can be included in an electronic controller. The parking status inference module 512 is configured to infer parking conditions during a respective parking session based on the data retrieved for that parking session from the online weather and geospatial data service 506 and the TCU 510. For example, the processor determines whether the EV was parked in a garage or in a location exposed to direct sunlight based on whether the sensor and battery temperatures were higher than the external temperature, and whether the temperatures were relatively high or low. The inferred parking conditions in module 512 can optionally be displayed to a GUI on an external device or a user interface in the EV.

The processor also accesses regional parking scores and information about various parking locations via a distributed cache 514. For example, the processor accesses a cloud data server to obtain aggregated parking scores and behaviors from similar users or vehicles or nearby locations to enrich the data stored in the local cache or local memory. The use of the distributed cache 514 to access additional parking scores beyond those stored locally is especially useful for unfamiliar or new parking locations.

In Step 516, the parking information from the EV cloud database is sent to a machine learning model and personalized parking spot recommendations for users are generated using the model. The data regarding the vehicle, the weather and the parking location during a parking session can optionally be used to perform feature extraction and imputation. Once the feature extraction and imputation has been performed, the output from the processor is fed into the machine learning model in Step 516 to train the model for later determination of parking scores. The machine learning model can predict a range of future state of health degradation of the EV battery, assign weights to certain parking environment features based on importance, use explainability tools to identify top contributors to battery state of health degradation, and determine rule-based parking scores to use in making a parking spot recommendation.

In Step 516, the processor is configured to generate base scores based on predefined rules regarding the environmental features of the parking locations. For example, if the type of parking environment is determined to be a garage, an average score can be adjusted by +10 points, and if the environment is determined to be an open shaded area, the score can be adjusted by +5 points, whereas street parking adjusts the score by −5 points, and extreme temperatures in the parking locations adjust the score by −15 points.

The processor can also be configured to assign weights to each of the feature categories and combine the rule-based scores with the weighted adjustments to arrive at a final parking score. For example, the adjustment for parking type (e.g., garage, open shaded area, street parking) can be assigned a weight of 40%, the adjustment for temperature can be assigned a weight of 30%, and other factors can be assigned a weight of 30%. The processor is configured to generate a score for each of the parking locations for each parking session by a user, and aggregate the parking scores over a period of time. The parking spot recommendation can be a recommendation to choose a particular location, or any suitable location among a plurality of locations, based on the parking scores and other conditions

The parking spot recommendation(s) is determined based on the parking scores. For example, the processor can determine a recommended parking spot by choosing the parking location with the highest parking score, the parking location closest to the current location of the vehicle, the parking location that is closest to a charging station, or by weighing the parking scores, proximity to the vehicle and proximity to a charging station and determining the location that achieves the desired balance of those variables.

In Step 518, the parking scores determined in Step 516 are stored in a local cache, for frequent locations, or a distributed cache on the cloud for new or infrequently used locations. It should be understood that the same location-based score for one user can lead to different outcome for vehicles with a different battery chemistry or vehicle age, or users with different user preferences and other constraints.

The parking spot recommendation is sent to a user terminal in Step 520 to display the parking spot recommendation(s) and receive user feedback regarding the parking spot recommendation(s). For example, if the user indicates that the recommendation is not feasible, the processor can ask the user for the underlying reason (e.g., absence or occupancy of a garage, occupancy, no garage, etc.). The processor can then dynamically cache the user-specific constraints in a local cache or local memory that can be periodically synchronized with cloud storage.

The aggregated parking scores can be updated based on the user feedback regarding the parking spot recommendation(s) or any recommended parking location(s). The processor can also utilize local and regional parking data to generate custom parking recommendations and suggestions for the user, which are displayed via a GUI on the user terminal or via the user interface of the vehicle.

In Step 522, the processor determines whether the parking behavior, which was based on the parking recommendation, is good. As shown in Step 524, a large language model (“LLM”) parking recommendation generator can provide information to the user based on the determination in Step 522. For example, if the parking behavior is determined to be good, the LLM parking recommendation generator can encourage the user to continue the behavior to maintain optimal parking practices and can highlight recent achievements on long-term battery health improvements. In contrast, if the parking behavior is determined to be bad, the LLM parking recommendation generator can trigger recommendations for behavior modification. For example, the LLM parking recommendation generator can recommend cooler or shaded locations to the user to prevent stress accumulation and can activate smart battery preconditioning or smart parking for longevity of the battery. The LLM parking recommendation generator can also recommend delaying or limiting charging to reduce long-term degradations and avoiding extended parking time with a drained battery.

By providing a process in which a parking recommendation for a vehicle is made based on information regarding the vehicle battery, a weather condition near the parking location, and geospatial information regarding an area around the parking location, the long-term battery health of the vehicle can be improved. Furthermore, by providing parking scores and/or a parking recommendation to a user of the vehicle, the health of the vehicle battery can be improved by taking into consideration parking conditions such as external temperature and environmental conditions and either automatically performing tasks to improve the battery health based on the recommended parking location or presenting recommendations to the user of the vehicle to improve the long-term battery health of the vehicle.

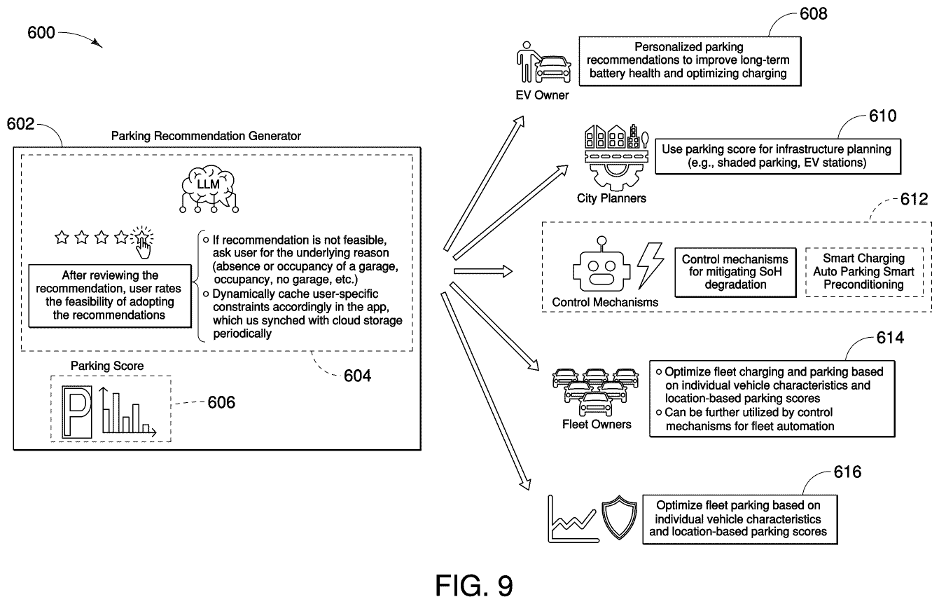

FIG. 9 shows a system 600 of managing the batteries of a plurality of vehicles according to a ninth embodiment. The system includes a parking recommendation generator 602. The parking recommendation generator 602 is configured to generate a parking recommendation for a user. The parking recommendation generator 602 includes a LLM 604, and a storage 606 for storing aggregated parking scores.

The parking recommendation generator 602 is any suitable electronic controller configured to communicate with an individual EV owner 608, city planners 610, control mechanisms 612, fleet owners 614 and a fleet control mechanism 616. The generator 602 includes one or more processors that execute predetermined control programs to determine a parking recommendation based on parking scores and transmit the recommendation to an EV or a user or manager of an EV. The parking recommendation can be determined in a manner discussed with respect to the embodiments described above.

The processors of the electronic controller include, for example, a CPU or a MPU. The electronic controller can include one or more microcomputers. Thus, the term “electronic controller” as used herein refers to hardware that executes a software program, and does not include a human.

The LLM 604 receives user feedback regarding the parking spot recommendation(s). For example, if the user indicates that the recommendation is not feasible, the LLM can ask the user for the underlying reason (e.g., absence or occupancy of a garage, occupancy, no garage, etc.). For example, the user may indicate that the recommendation is not feasible if the user does not have access to a shaded parking spot, or the recommendation does not capture personal preferences (e.g., saving best spot for another household member). The LLM can then dynamically cache the user-specific constraints in a local cache or local memory that can be periodically synchronized with cloud storage. The caching strategy ensures that user feedback is stored locally and synchronized with the cloud to support continuous learning and user specifications.

The storage 606 includes a local cache or a distributed cache on the cloud. The local cache can store parking scores for frequently used locations, and the distributed cache can store parking scores for new or infrequently used locations. It should be understood that the same location-based score for one user can lead to different outcome for vehicles with a different battery chemistry or vehicle age, or users with different user preferences and other constraints.

The parking recommendation generator 602 is in communication with the individual EV owner 608. The EV is any suitable electric vehicle that includes a battery and can be charged and discharged, such as a hybrid vehicle or a fully electric vehicle. The EV can include a bidirectional charging port that is configured to allow charging and discharging of the vehicle, or a unidirectional charging port that is configured to allow only charging of the vehicle. The parking recommendation generator 602 is configured to send personalized parking recommendations to the EV owner 608 to improve the long-term battery health and optimize charging of the EV.

The parking recommendation generator 602 is also in communication with city planners 610. The parking recommendation generator 602 is configured to send personalized parking recommendations to the city planners 610 for use in infrastructure planning. For example, the city planners 610 can use the information from the parking recommendation generator 602 to design shaded parking in certain locations or to decide where to build EV charging stations.

The parking recommendation generator 602 is in communication with control mechanisms 612 for mitigating the state of health degradation of one or more EV batteries. For example, the parking recommendation generator 602 is configured to send commands directly to at least one EV to control at least one of the preconditioning of the at least one EV, the charging of the at least one EV battery, and the parking of the at least one EV. For example, the parking recommendation generator 602 is configured to control the battery management system of the at least one EV to precondition the battery based on the parking scores and/or the parking recommendation for each vehicle. The parking recommendation generator 602 is also configured to control the at least one EV to charge the battery of the at least one EV based on the parking scores and/or the parking recommendations. The parking recommendation generator 602 can also be configured to control the at least one EV to perform auto-parking in the recommend parking spot(s).

The parking recommendation generator 602 is in communication with fleet owners 614. The fleet owners 614 own a plurality of rental vehicles. The rental vehicles are all EVs, but some of the rental vehicles can be economy EVs that are more fuel-efficient and cost-effective for customers, while other rental vehicles can be luxury or premium EVs that are more spacious or include more features than an economy EV. The parking recommendation generator 602 is configured to send parking recommendations to the fleet owners 614 to optimize fleet charging and parking based on individual vehicle characteristics and location-based parking scores.

The parking recommendation generator 602 is also in communication with a fleet control mechanism 616. The parking recommendation generator 602 is configured to send parking recommendations to the fleet control mechanism 616 to optimize fleet parking based on individual vehicle characteristics and location-based parking scores. The fleet control mechanism 616 can also use the parking recommendations to perform automated tasks, such as smart preconditioning, smart charging and auto-parking, of the vehicles in the fleet.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, should also be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A system for managing a battery of a vehicle, the system comprising:
a server configured to, for each parking session at each of a plurality of locations, acquire parking information for the vehicle during the parking session, the parking information including: information regarding the battery of the vehicle, a weather condition in a predetermined area around the location, and geospatial information regarding an area surrounding the location; and
a controller configured to determine at least one parking score for each of the plurality of locations based on the parking information for the location, the controller being configured to determine the parking scores using a lookup table or a machine learning model;
the controller being configured to determine a recommended parking location from the plurality of locations based on the parking scores.

2. The system according to claim 1, further comprising
a user terminal configured to communicate with the controller,
the controller being configured to determine a recommended parking location for the vehicle from the plurality of locations in response to an input from the user terminal.

3. The system according to claim 1, further comprising
a local cache configured to store parking scores for at least a first portion of the plurality of locations.

4. The system according to claim 1, wherein
the controller is configured to communicate with a distributed cache configured to store parking scores for at least a second portion of the plurality of locations.

5. The system according to claim 1, wherein
the controller is configured to determine the at least one recommended parking location based on a battery health of the battery.

6. The system according to claim 1, wherein:
the parking scores are stored in a local cache or a server, and
the at least one parking score for each location is configured to be updated after each parking session corresponding to that location.

7. The system according to claim 1, wherein:
the controller is configured to send the recommended parking location to a user terminal, and
the user terminal is configured to display the recommended parking location to a user.

8. The system according to claim 1, wherein
a plurality of parking scores are associated with each location, and the plurality of parking scores for each location vary based on a time of day.

9. The system according to claim 1, wherein
the geospatial information regarding the area surrounding the location includes information regarding whether the location is exposed to sunlight.

10. The system according to claim 1, wherein
the at least one parking score is based on user feedback from the user terminal.

11. The system according to claim 1, wherein
the controller is configured to initiate an automated action selected from the group consisting of: smart preconditioning of the battery, smart charging of the battery, and automatic parking relocation of the vehicle.

12. A system for managing a plurality of batteries of a plurality of vehicles, the system comprising:
a server configured to, for each parking session for each of the plurality of vehicles at each of a plurality of locations, acquire parking information for one of the plurality of vehicles during the parking session, the parking information including: information regarding the battery of the one of the plurality of vehicles, a weather condition in a predetermined area around the location, and geospatial information regarding an area surrounding the location; and
a controller configured to determine at least one parking score for each of the plurality of locations based on the parking information for the location, the controller being configured to determine the parking scores using a lookup table or a machine learning model;
the controller being configured to determine a recommended parking location for one of the plurality of vehicles from the plurality of locations based on the parking scores.

13. The system according to claim 10, further comprising
a local cache configured to store parking scores for at least a first portion of the plurality of locations.

14. The system according to claim 10, wherein
the controller is configured to communicate with a distributed cache configured to store parking scores for at least a second portion of the plurality of locations.

15. The system according to claim 10, wherein:
the parking scores are stored in a local cache or a server, and
the at least one parking score for each location is configured to be updated after each parking session corresponding to that location.

16. The system according to claim 10, wherein:
the controller is configured to send the recommended parking location to the user terminal, and
the user terminal is configured to display the recommended parking location to a user.

17. The system according to claim 10, wherein
the geospatial information regarding the area surrounding the location includes information regarding whether the location is exposed to sunlight.

18. The system according to claim 10, wherein
the at least one parking score is based on user feedback from the user terminal.

19. A method for managing a battery of a vehicle, the method comprising:
acquiring, for each parking session at each of a plurality of locations, parking information for the vehicle during the parking session, the parking information including:
information regarding the battery of the vehicle, a weather condition in a predetermined area around the location, and geospatial information regarding an area surrounding the location;
determining at least one parking score for each of the plurality of locations based on the parking information for the location, the parking scores being determined using a lookup table or a machine learning model; and
determining a recommended parking location for the vehicle from the plurality of locations,
the recommended parking location being determined based on the parking scores.

20. The method according to claim 19, further comprising
storing parking scores for at least a first portion of the plurality of locations in a local cache.
